(19) United States
(12) Patent Application Publication
(10) Pub. No.: US 2008/0277049 A1
(43) Pub. Date: Nov. 13, 2008

(54) Method and Device for Adhering Components to a Composite Molding

(76) Inventors: Geerardus Hubertus Joannes Jozeph Roebroeks, Den Bommel (NL); Erik Jan Kroon, Rotterdam (NL)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/088,189

(22) PCT Filed: Sep. 25, 2006
(86) PCT No.: PCT/NL2006/050235

§ 371 Date: Jul. 18, 2008

(30) Foreign Application Priority Data
Sep. 26, 2005 (NL) 1030029

(51) Int. Cl. B29C 65/48; B32B 37/10

(52) U.S. Cl. 156/221; 156/381

(57) ABSTRACT

The invention relates to a method for adhering components to a composite molding. The method comprises stacking the components provided with an appropriate bonding means, positioning a heating means (11), provided with at least one cavity (12), over at least a section of the stack, and passing a medium brought to a first temperature through the at least one cavity of the heating means, whereby the stack is brought at least partially to the first temperature, and the components are interconnected to the molding. The invention also relates to a device for implementing the method and a heatable membrane that can be applied in the method.

The invention relates to a method for adhering components to a composite molding. The invention also relates to a device for producing the composite molding.

In the industry, and in the aircraft construction industry in particular, methods are often applied whereby components such as fuselage parts, wing profiles and stiffeners are adhered to a composite molding using for example a thermosetting adhesive. To this end, the components to be adhered are provided with an adhesive layer and are then connected to each other. The bond between the components is obtained by curing the thermosetting bonding means, by bringing it to a first increased temperature. It is important inter alia to remove as much air as possible that may be present between the components and/or in the adhesive layer as this makes it possible to achieve the desired good bond between the components. A known method thus comprises retaining the components in a vacuum-sealed film, whereby the pressure required to expel the air is exerted by applying a vacuum pressure in the space between film and components. An improved known method is implemented in a pressure vessel or autoclave, the inside volume of which can be controlled in terms of both temperature and pressure. The processes of temperature treatment required for adhering the components (this treatment generally comprises curing the thermosetting adhesive), de-aeration and pressurizing of the components are thus combined in a single device.

Although moldings with good mechanical properties can be obtained with the existing method, it is particularly time-consuming. Due to the high risks involved in applying moldings in the aircraft industry, it is very important to ensure that the adhesive layers are kept at the first temperature for a sufficient period of time during the known method, to guarantee the effective curing thereof. A typical autoclave cycle generally lasts for several hours. This time is needed to bring the composite molding (components and adhesive layers) to the desired first temperature, and then to cool it down again to a temperature at which it can be removed from the autoclave. The known method also generally requires high investment in autoclaves and peripheral equipment. The larger the dimensions of the moldings to be produced, the higher the investment. In a growing number of areas of application, there is a clear trend toward larger moldings.

The object of this invention is to provide a more efficient method for adhering components to a composite molding, whereby the molding also demonstrates good mechanical properties.

The method according to the invention for adhering components to a composite molding is thereto characterized as referred to in claim 1. More particularly, the method comprises stacking the components provided with an appropriate bonding means, positioning a heating means, provided with at least one cavity, over at least a section of the stack, and passing a medium brought to a first temperature through the at least one cavity of the heating means, whereby the stack is brought at least partially to the first temperature, and the components are interconnected to the molding. By means of the measures referred to in claim 1, it is inter alia achieved that the average cycle time for producing the molding can be significantly shorter, thus making the method according to the invention more efficient than the known method. Because the heating means can be positioned in the direct vicinity of the adhesive layers to be heated, the molding is indeed only brought to the desired temperature where this is required. In the known autoclave method, the entire inside space of the autoclave must be brought to the desired first temperature, which is time-consuming. A further advantage of the method according to the invention is that it only requires a little energy, because only those sections of a device appropriate for the method that are necessary to form the molding are heated up. Furthermore, it is possible with the method according to the invention, where so desired, to achieve a very rapid heating and/or cooling rate, because a mass of the medium can already be brought to the first temperature before being passed through the heating means.

Although in the method according to the invention, it is in principle possible to apply any medium that can be pumped relatively simply, a liquid is preferably passed through the cavity (cavities). Liquids are simple to pump and can convey a large quantity of heat. Appropriate liquids can for example be water, oil and/or other liquids that can be brought to the first temperature.

In a preferred embodiment of the method according to the invention, the heating means is designed such that when positioning it on the stack, it substantially takes on the form of the surface of the stack. This is advantageous for the transfer of heat between heating means and stack. It should be noted that the heating means according to the invention cannot be of such a stiffness that it is able to substantially deform the stack, as would be the case for example with a pressure plate provided with heating channels.

In a further preferred embodiment of the method according to the invention, a heating means is applied in the form of a flexible membrane, provided with an inlet and outlet for the medium, preferably a liquid. Such a membrane is simple to affix and can be used more than once if desired. By preferably selecting a very extensible and elastic material for the membrane material, the heating means can be affixed to the stack with a good fit, thus enabling an effective transfer of heat from heating means to molding even with moldings having a complex form. According to the invention, the heatable membrane can for example comprise a heat-resistant, elastic matrix, such as a silicon rubber or modified silicon rubber. Most preferably, this is a natural rubber or elastomer.

According to the invention, at least one medium brought to the first temperature must be pumped through the cavity (cavities) of the heating medium. The first temperature is selected such that the components can interconnect at this temperature by keeping at least the adhesive layers at this temperature for an appropriate period of time. If the bonding means between the components to be adhered comprises a thermosetting polymer, the first temperature is preferably selected such that it is at least equal to the curing temperature of the thermosetting polymer. If the bonding means comprises a semi-crystalline thermoplastic polymer, the first temperature is preferably selected such that it is higher than the melting temperature of the thermoplastic polymer. If the bonding means comprises an amorphous thermoplastic polymer, the first temperature is preferably selected such that it is at least equal to the softening temperature of the thermoplastic polymer.

It turned out that with the method according to the invention, the time required to adhere the components can be significantly shorter than is the case with the known method. To further reduce this time, in addition to passing the medium brought to the first temperature through at least one cavity of the heating means, it is advantageous to pass a medium brought to a second temperature through the heating means. The second temperature is selected such that the components interconnect at this temperature and the composite molding can be stored and/or loaded. If the bonding means between the components to be adhered comprises a thermosetting polymer, the second temperature is preferably selected such that it is lower than the curing temperature of the thermosetting polymer. If the bonding means comprises a semi-crystalline thermoplastic polymer, the second temperature is preferably selected such that it is lower than the melting temperature of the thermoplastic polymer. If the bonding means comprises an amorphous thermoplastic polymer, the second temperature is preferably selected such that it is lower than the softening temperature of the thermoplastic polymer. The medium brought to a second temperature can comprise the same medium as the medium brought to the first temperature, but this is not a prerequisite. In other words, it is possible to apply different media (for example a liquid and a gas, or several liquids having different properties) in the method according to the invention. The medium brought to a second temperature can be passed through before, and/or during and/or after the medium brought to the first temperature has been passed through. If media brought to different temperatures are passed through the cavity (cavities) at approximately the same time, the average temperature thereof while being passed through will be between the first and second temperature. Such an embodiment makes it possible to control the temperature of the heating means in an almost continuous fashion. For instance, it is possible to change over very gradually from the first to the second temperature by mixing the flow of the medium brought to the first temperature with a flow of medium brought to the second temperature, whereby the flow rate of the latter medium is gradually increased. The reverse, namely changing over very rapidly from the first to the second temperature, is also possible, in turn making it possible, when applying thermoplastic polymers, to control the crystallinity thereof. It should be noted that the person skilled in the art has various options available in this respect. The characteristics of the method according to the invention make it possible to obtain a sensitive means of controlling temperature, which furthermore requires relatively little energy.

In a further preferred embodiment, the method according to the invention is characterized in that a medium brought to a first temperature is passed through a first cavity, and a medium brought to another temperature is passed through another cavity of the heating means, whereby the corresponding sections of the laminate are brought to the first, or respectively the other, temperature.

This can be highly advantageous, for example if another polymer is applied as an adhesive material or bonding means in different parts of the molding to be produced, thus requiring this polymer for example to be cured at another temperature. It is also possible with this preferred method to switch rapidly from a higher temperature to a lower (cool) temperature.

In the method according to the invention, pressure is preferably exerted on the molding for at least some of its production time. More preferably, the pressure is exerted by retaining the assembly of stack and heating means between a substrate and a flexible retaining body, between which a vacuum pressure is then applied. By applying an at least partial vacuum, not only is an effective evacuation of air achieved in the adhesive layers, but also the contact between the stack and adjacent heatable membrane is improved, thus facilitating the heat transfer from membrane to stack. The stack is also effectively held in position by the vacuum. For the same reasons, it can be advantageous where necessary to apply an overpressure to the outside of the assembly of stack, heating means and flexible body in the method according to the invention.

A particularly appropriate method according to the invention is characterized in that the pressure is exerted by retaining the assembly of stack and heating means between the substrate and a stiff retaining body, and the medium, in this case the liquid, is passed through the heating means subjected to such a pressure that the heating means expands and is pressed against the retaining body. The retaining body can for example be connected to a section of the substrate. This variant does not require any separate pressurizing device and is therefore more efficient. The pressure on the stack is indeed autonomously established by the hydrostatic pressure present in the heating means. The method according to the invention can be advantageously applied for producing a molding made of a fiber-reinforced material. Fiber-reinforced materials, also referred to in the industry as composites, are obtained by impregnating reinforcing fibers with an appropriate matrix material to create single-layer semi-finished products (“prepregs”) or multi-layer laminates. In this way, the matrix material acts as a means of bonding the reinforcing fibers and prepregs to each other, and can be both heat-curable (thermosetting) and heat-meltable (thermoplastic). When producing moldings made of fiber-reinforced material, generally several layers of fiber-reinforced material (as set out in claim 1, each layer corresponds to a component) are stacked on top of each other, after which this stack is molded into a molding in a molding tool while being subjected to temperature and possibly pressure. To ensure inter alia that the various layers of the composite effectively bond to each other and as much air as possible that may be present in and/or between these layers is removed, the known methods preferably apply molding tools that can exert a pressure on the molding while it is being produced. For instance, a molding can be molded in a temperature-controlled compression press. Another frequently applied method comprises retaining the laminate in a vacuum-sealed film, whereby the pressure required to expel the air is exerted by applying a vacuum pressure in the space between film and laminate. This known method is generally implemented in a pressure vessel or autoclave, in which the temperature can be controlled and an additional pressure can be exerted on the laminate. However, the known method has the same disadvantages as referred to above, including low efficiency. For instance, the known autoclave process typically lasts for 3 to 5 hours. The method according to the invention makes it possible to obtain a molding made of fiber-reinforced material in 1 to 1.5 hours.

It is also possible to use the method according to the invention to connect several moldings to each other. In such cases, the substrate comprises a second molding and the laminate brought to the first temperature is held against the second molding for an appropriate period of time, thus interconnecting the laminate and the second molding. In a preferred embodiment, the second molding is provided with an adhesive layer at the applicable sections thereof before the laminate is affixed to this second molding.

The method according to the invention can in principle be applied to the production of moldings made of any fiber-reinforced material. The method is also advantageous in that it can be applied for fiber-reinforced materials with a thermosetting as well as a thermoplastic matrix. In a preferred embodiment of the method, at least one of the fiber-reinforced material layers comprises a thermoplastic polymer, whereby after the medium brought to the first temperature has passed through the at least one cavity of the heating means, a medium brought to a second temperature is passed through the heating means, with the first, or respectively second, temperature being higher, or respectively lower, than the melting temperature of the thermoplastic polymer. This makes it possible to bring the thermoplastic polymer relatively rapidly to below its melting temperature, which is in turn advantageous for the cycle time. Examples of thermoplastic polymers that are appropriate for the method according to the invention are polyamides, polyimides, polyethersulphones, polyetheretherketone, polyurethane, polyethylene, polypropylene, polyphenylene sulphides, polyamide-imides, acrylonitrile butadiene styrene (ABS), styrene/maleic anhydride (SMA), polycarbonate, polyphenylene oxide blend (PPO), thermoplastic polyesters such as polyethylene terephthalate, polybutylene terephthalate, as well as mixtures and copolymers of one or more of the above polymers.

In yet another preferred embodiment, the method according to the invention is characterized in that at least one of the fiber-reinforced material layers comprises a thermosetting polymer, and in that the first temperature is higher than the curing temperature of the thermosetting polymer. Also when using thermosetting matrix materials, it is possible to apply a medium brought to a second or further temperature if desired. The second temperature is in this case preferably lower than the curing temperature of the thermosetting polymer and can for example temporarily keep the viscosity of the matrix at a low level, to improve impregnation and interconnection of the layers, or to enable more air to be discharged. Thermosetting polymers that are appropriate for use include for example epoxies, unsaturated polyester resins, melamine/formaldehyde resins, phenol formaldehyde resins, polyurethane, etcetera.

When reference is made in this application to a first and second temperature, it is understood to mean an average temperature. It should be noted that when reference is made for instance to bringing the laminate to a first temperature, this means that the laminate has on average assumed the first temperature, subject to local variations. The same applies for the second and further temperatures.

Reinforcing fibers that are appropriate for use in the fiber-reinforced materials include for example glass fibers, carbon fibers, metal fibers, drawn thermoplastic polymer fibers, such as aramid fibers, PBO fibers (Zylon®), M5® fibers, and ultrahigh molecular weight polyethylene or polypropylene fibers, as well as natural fibers such as flax, wood and hemp fibers, and/or combinations of the above fibers. It is also possible to use commingled and/or intermingled rovings. Such rovings comprise a reinforcing fiber and a thermoplastic polymer in fiber form.

The fiber-reinforced plastic layer preferably comprises substantially continuous fibers that extend in at least two almost orthogonal directions (isotropic woven fabric). In another preferred embodiment, the fibrous layer and/or the fiber-reinforced plastic layer comprise substantially continuous fibers that mainly extend in one direction (UD tissue). The specific type of woven fabric selected depends inter alia on the desired mechanical properties and the deformability of the woven fabric. The selected embodiment of the method according to the invention can be a significant factor in this respect.

In a particular preferred embodiment, the method according to the invention is characterized in that the laminate comprises at least one metal layer. Such laminates are also known as fibrous metal laminates and comprise one or more metal layers and intermediary fiber-reinforced plastic layers. The laminates referred to are obtainable by connecting a number of metal layers and intermediary fiber-reinforced plastic layers to each other by means of heating under pressure and then cooling them. The fiber-reinforced plastics applied in the fibrous metal laminates are light and strong and comprise reinforcing fibers embedded in a polymer. The polymer also acts as a bonding means between the various layers.

Fibrous metal laminates have good specific mechanical properties (properties per unit of density). Metals that are particularly appropriate to use include light metals, in particular aluminum alloys, such as aluminum copper and/or aluminum zinc alloys, or titanium alloys. In other respects, the method according to the invention is not restricted to producing moldings based on laminates using these metals, so that if desired steel can be used for example or another appropriate structural metal.

It turned out that by applying the method according to the invention, the bond between the components, and/or impregnation of the laminate are improved without it being necessary for example to work under a pulsating pressure. Where necessary it can be advantageous, if the medium, preferably the liquid, is brought on average to the first temperature and then passed through the at least one cavity of the heating means under a pulsating temperature. Pulsating in this respect is understood to mean both continuously pulsating (like a wave) and discontinuously pulsating (in the sense of peaks). Such a preferred embodiment can lead to better properties and a shorter process cycle. By affixing the concave and flexible membrane on the stack according to the invention and for example pressing it tightly against the stack by means of vacuum pressure, a profound contact is created between membrane and stack, enabling heat to be rapidly exchanged between the medium pumped through the membrane and the stack. This rapid heat exchange makes it possible to apply a pulsating temperature, which also actually affects the bonding means.

The invention also relates to a device for adhering components to a composite molding, said device at least comprising a liquid source and means for bringing the liquid to a first temperature; and heating means that can be affixed on the molding, provided with at least one cavity and connection means connecting thereto for feeding and draining the liquid, and pumping means for passing the liquid through the at least one cavity. Further particular embodiments of the device according to the invention are referred to in claims 15 to 23.

When reference is made in this application to heating means, this must also be understood to mean cooling means. The term heating must therefore be broadly interpreted in this application, as it can also refer to cooling. The method and device according to the invention will emerge from the accompanying figures, in which:

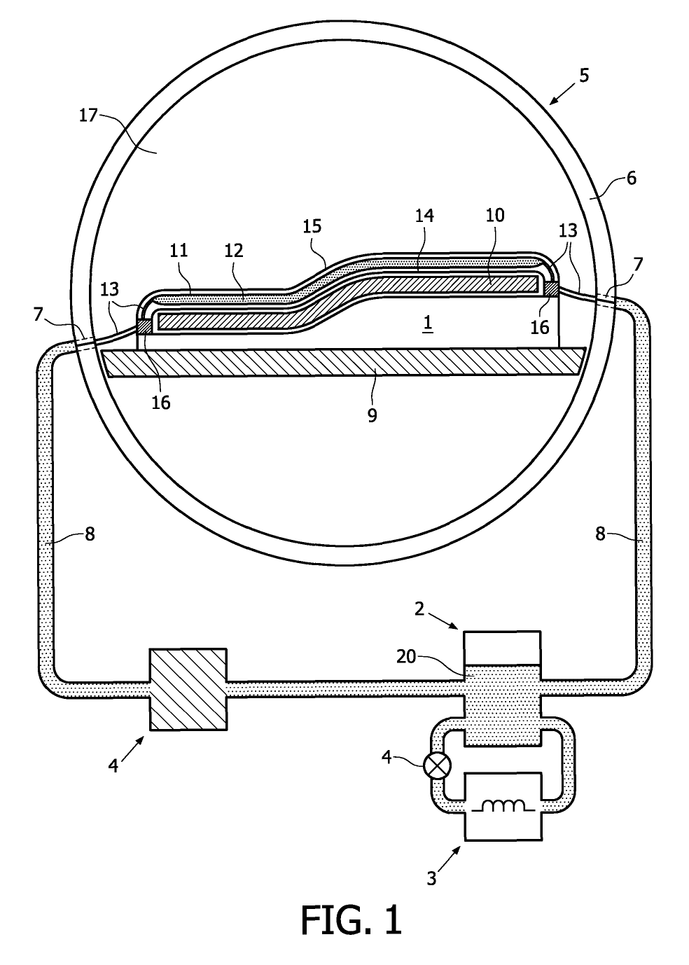

FIG. 1 schematically shows a cross-section of a first embodiment of the device according to the invention;

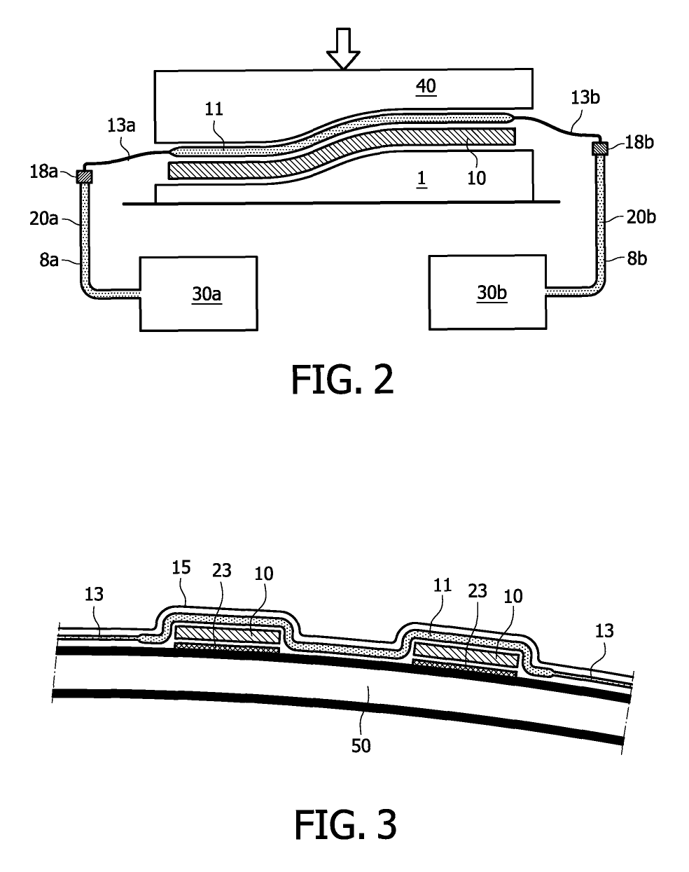

FIG. 2 schematically shows a cross-section of a second embodiment of the device according to the invention;

FIG. 3 schematically shows a cross-section of a third embodiment of the device according to the invention;

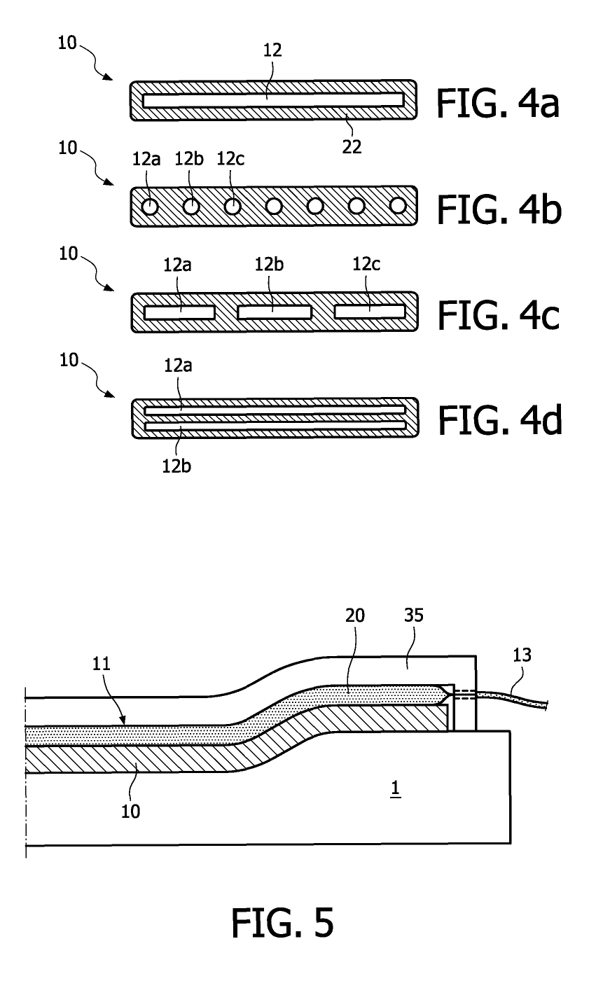

FIG. 4 shows several cross-section views of a heating means that can be applied in the method according to the invention;

FIG. 5 finally schematically shows a cross-section of a fourth embodiment of the device according to the invention.

With reference to FIG. 1, an embodiment of a device according to the invention comprises at least a forming mold 1 on which a laminate 10 made of fiber-reinforced material layers can be affixed, a liquid source or tank 2 and means 3 for bringing the liquid 20 to a first temperature; heating means 11 that can be affixed on the laminate 10, said means provided with at least one cavity 12 and connection means 13 connecting thereto for feeding and draining the liquid, and pumping means 4 for passing the liquid 20 through the at least one cavity 12. In the embodiment shown, the overall structure is incorporated in a pressure vessel or autoclave 5 with a wall 6, through which the pipes 8 for the liquid 20 are affixed via passage openings 7. The pressure vessel 5 is resistant to the typical pressures that are usual in producing moldings made of fiber-reinforced plastics, for example an internal pressure of at least 10 bar. Forming mold 1 is affixed to a table 9 present in the autoclave 5 for support. It should also be noted that one or more pressure valves are in practice incorporated in pipe 8, to prevent the overall pipe assembly from being exposed to constant pressure. In a preferred embodiment (not shown), the pumping means 4, pipes 8, liquid source 2, and heating means 3 are all incorporated in the pressure vessel 5, because this is advantageous from a safety perspective.

In practice, a laminate 10 made of fiber-reinforced material layers is affixed on the substrate 1. The heating means 11, preferably in the form of a concave flexible membrane, is then affixed over at least a section of the laminate 10. The membrane is connected to the pipes 8 via connection means 13. If desired, auxiliary materials 14 are used when affixing the fiber-reinforced material 10 on the forming mold 1. Such auxiliary materials for producing fiber-reinforced moldings are known to the person skilled in the art, and are applied for example to give the molding a rough surface (“peel ply”), to collect excess polymer (“bleeder”), or to be able to discharge air easily (“breather”). In the variant shown in FIG. 1, the assembly of laminate 10 and heating means 11 is retained in a flexible retaining body 15, generally in the form of a flexible polymer film. Film 15 is connected to forming mold 1 in an almost airtight fashion along the entire circumference of the molding 10 by means of a rubber-like connecting strip 16. Due to this airtight connection, the assembly of laminate 10, heating means 11 and any auxiliary materials 14 are sealed in an almost airtight fashion from the rest of the autoclave space 17. If desired, the space between film 15 and forming mold 1 can be subjected to a vacuum pressure, by connecting this space up to a vacuum pump (not shown). This vacuum ensures that the various layers of the laminate 10 are pressed onto each other and that any air present between and/or in the layers is at least partially expelled from the laminate 10. If desired, the space 17 can also be subjected to overpressure. To bring the laminate 10 to the desired first temperature—the first temperature can for example be the temperature at which the thermosetting polymer is cured—a liquid 20 brought to the first temperature by means of heat exchanger 3 is pumped through the cavity 12 of the heating membrane 11 by pump 4. The liquid 20 in the cavity 12 at the first temperature will exit at a lower temperature by means of heat exchange with laminate 10. Because the cavity 12 preferably only represents a very small volume, it is possible to achieve a highly accurate temperature control, because heated liquid 20 can be fed in within a very short period of time. The known heating method is much slower and less accurate, because it heats the complete space 17 using air. By keeping the laminate 10 at the first temperature for an appropriate period of time and if desired exerting pressure, the polymer present therein will cure and the material layers will interconnect to the molding.

With reference to FIG. 2, another embodiment of the device according to the invention comprises two liquid sources 30a, 30b from which two liquid flows 20a, 20b can be fed and drained via pipes 8a, 8b. The pipes 8a, 8b are joined to the connections 13a, 13b via coupling pieces 18a, 18b. Although not shown in FIG. 2, the liquid sources 30a, 30b shown schematically in this figure each comprise the parts indicated in FIG. 1, such as pumps, heat exchangers, etcetera. Furthermore, the pressurizing means in the present exemplary embodiment comprises a compression press (schematically indicated by means of the arrow) that can move two mold halves 1 and 40 toward each other. The two liquid flows 20a, 20b can for example be used to make it possible to rapidly change the temperature in the heating means 11 (and thus in the laminate 10). To this end, the heating means 10 can be provided with several cavities 12a, 12b, . . . separated from each other and corresponding connection means 13a, 13b, . . . for feeding and draining a liquid 20a, 20b, . . . . Different variants hereof are shown in FIG. 4. In FIG. 4a, the heating membrane 10 comprises a wall section 22 made of a sufficiently temperature-resistant flexible and elastic material, such as rubber for example, and one central cavity 12. In FIGS. 4b and 4c, the heating membrane 10 comprises a number of cavities 12a, 12b, . . . with a circular or rectangular cross-section respectively. These cavities can be connected to the same liquid source or if desired can also have liquids flow through them, which have each been brought to a different temperature. FIG. 4d finally shows a heating membrane 10 that is provided with a first cavity 12a, through which a liquid 20a brought to a first temperature can be passed, and a second cavity 12b, through which a liquid 20b brought to another temperature can be passed. According to the invention, a liquid 20a brought to the curing temperature is for example pumped through cavity 12a in order to cure the laminate 10. Once it has been sufficiently cured, the laminate 10 must be cooled. This can naturally take place by terminating the liquid flow 20a. However, this takes time. To speed up the cooling process, it is now also possible to pump liquid 20b already brought to a lower temperature through cavity 12b. This leads to a more rapid cooling of the laminate 10, whereby the heating membrane 10 is preferably positioned against laminate 10 on the side on which cavity 12b is located (in FIG. 4d this is the bottom side). It is also possible to use the method according to the invention to connect several moldings to each other. With reference to FIG. 3, a cross-section of an aircraft wing profile 50 is shown. When in use, aircraft wings are subject to alternating loads and are therefore provided with stiffeners 10, for example made of fibrous metal laminate. Such a stiffener 10 is in practice affixed over almost the entire length of the aircraft wing 50 to be reinforced. To this end, the stiffener 10 is affixed on the part and bonded thereto using an adhesive appropriate for the purpose. If fatigue cracks develop in the part when subjected to the alternating load and they continue to grow under the stiffener, said stiffener will generally remain intact in practice and span the cracks in the molding, thus ensuring at least a deceleration in average crack growth when subjected to alternating load. To reinforce the molding 50, an adhesive layer 23 is applied to the applicable sections of wing 50 according to the present exemplary embodiment. Strips of fibrous metal laminate 10 are then placed on top of this, over which a heating membrane 11 is positioned. The overall structure is then covered with a flexible film 15 that is connected to the surface of the wing 50 in an airtight fashion along the circumference using sealing means 16. By discharging the air lying there between using a vacuum pump (not shown), the film is pulled tightly over the assembly of laminate 10 and heating membrane 11. By now passing a liquid brought to the curing temperature of the adhesive layer through membrane 11, laminate 10 and adhesive layer 23 are brought to the curing temperature, causing the adhesive layer and possibly also the laminate to cure, thus interconnecting laminate 10 and molding 50. Second moldings of the type referred to generally have large dimensions. The usual method, whereby an autoclave is applied to bring the adhesive layer to temperature, entails high costs. The method according to the invention does not have this disadvantage.

With reference to FIG. 5, another preferred embodiment of the method according to the invention is finally shown, whereby pressure is also exerted on the laminate 10 while the liquid 20 is passed through the heating membrane 11. This pressure is established by retaining the assembly of laminate 10 and heating means 11 between the surface of forming mold 1 and a stiff retaining body 35, and passing the liquid 20 through the heating means 11 under such a pressure that the heating means expands and is pressed against the retaining body 35. Depending on the intermediate distance between body 35 and forming mold 1, the pressure can be set at the desired level. Retaining body 35 can for example comprise a flat plate that can be fastened to the substrate by means of an appropriate connection (not shown) via at least a section of its circumference, preferably by means of a detachable connection.

1-25. (canceled)

26. A method for forming a molding comprising:
providing a pressure vessel having a mold;
stacking component layers onto the mold, a bottom surface of a first component layer positioned directly above the mold such that the bottom surface takes on a shape of the mold;
positioning a flexible membrane over at least a portion of a top surface of a final component layer such that the flexible membrane takes on a shape of the top surface of the final component layer;
heating a medium to a first heated temperature; and
pumping the heated medium at the first heated temperature for a period of time through the flexible membrane to transfer the first heated temperature to the component layers such that the component layers are adhered to one another to result in the molding.

27. The method of claim 26 wherein the resulting molding is made of component layers that include an at least one matrix layer and an at least one fiber layer.

28. The method of claim 27 wherein the at least one matrix layer includes a thermosetting polymer and the first heated temperature is at least equal to or higher than a curing temperature of the thermosetting polymer.

29. The method of claim 27 wherein the at least one matrix layer includes a thermoplastic polymer and the first heated temperature is at least equal to or higher than a melting temperature of the thermoplastic polymer.

30. The method of claim 26 further comprising:
covering the flexible membrane with a retaining body that connects with the mold such that a substantially airtight space is created between the retaining body and the mold; and
exerting an at least partial vacuum pressure in the airtight space such that any air present in and/or between the component layers will be removed.

31. The method of claim 26 wherein the medium is a liquid selected from the group consisting of water and oil.

32. The method of claim 26 further comprising:
heating the medium to a second heated temperature; and
pumping the heated medium at the second heated temperature for a period of time through the flexible membrane to transfer the second heated temperature to the component layers.

33. The method of claim 26 wherein the flexible membrane has at least one cavity for passage of the heated medium.

34. The method of claim 26 further comprising:
providing a second mold in the pressure vessel, a bottom surface of the second mold positioned directly above the flexible membrane;
moving the mold and the second mold toward each other using a pressurizing means; and
exerting pressure on the component layers, such that any air present in and/or between the component layers will be removed.

35. The method of claim 26 further comprising exerting a pressure throughout the pressure vessel.

36. A method for adhering at least one molding to an aircraft component comprising:
providing a pressure vessel having an aircraft component;
stacking at least one molding onto the aircraft component, wherein an adhesive material is positioned between the at least one molding and the aircraft component;
positioning a flexible membrane over at least a portion of a top surface of the at least one molding such that the flexible membrane takes on a shape of the top surface of the at least one molding;
heating a medium to a first heated temperature; and
pumping the heated medium at the first heated temperature for a period of time through the flexible membrane to transfer the first heated temperature to both the at least one molding and the adhesive material such that the at least one molding is adhered to the aircraft component.

37. The method of claim 36 wherein the at least one molding is a fibrous metal laminate that includes an at least one fiber-reinforced material layer and an at least one metal layer.

38. The method of claim 36 wherein the medium is a liquid selected from the group consisting of water and oil.

39. The method of claim 36 further comprising:
heating the medium to a second heated temperature; and
pumping the heated medium at the second heated temperature for a period of time through the flexible membrane to transfer the second heated temperature to both the at least one molding and the adhesive material.

40. The method of claim 36 wherein the flexible membrane has at least one cavity for passage of the heated medium.

41. The method of claim 36 further comprising:
covering the flexible membrane with a flexible film that connects with the aircraft component such that a substantially airtight space is created between the flexible film and the aircraft component; and
exerting an at least partial vacuum pressure in the airtight space such that any air present in and/or between the adhesive material and the aircraft component will be removed.

42. The method of claim 36 further comprising exerting a pressure throughout the pressure vessel.

43. A device for forming a molding comprising:
a pressure vessel having a mold to which component layers are stacked onto, a bottom surface of a first component layer positioned directly above the mold such that the bottom surface takes on a shape of the mold;
a flexible membrane positioned over at least a portion of a top surface of a final component layer such that a heated medium flowing through the flexible membrane is capable of transferring heat to the component layers; and
a heating means for heating the medium to at least a first heated temperature,
wherein the heated medium is then pumped for a period of time through the flexible membrane such that the component layers are adhered to one another.

44. The device of claim 43 further comprising:
a retaining body covering the flexible membrane, the retaining body connecting with the mold such that a substantially airtight space is created between the retaining body and the mold,
wherein an at least partial vacuum pressure is exerted in the airtight space such that any air present in and/or between the component layers will be removed.

45. The device of claim 43 wherein the medium is a liquid selected from the group consisting of water and oil.
